(19) United States
(12) Patent Application Publication
(10) Pub. No.: US 2014/0206359 A1
(43) Pub. Date: Jul. 24, 2014

(54) SYSTEM AND METHOD FOR MANAGING A WIRELESS NETWORK

(71) Applicant: Alcatel-Lucent USA Inc., Murray Hill, NJ (US)

(72) Inventors: Subramanian VASUDEVAN, Morristown, NJ (US); Rahul PUPALA, Piscataway, NJ (US); Sivarama VENKATESAN, Milltown, NJ (US)

(73) Assignee: Alcatel-Lucent USA Inc., Murray Hill, NJ (US)

(21) Appl. No.: 13/746,013

(22) Filed: Jan. 21, 2013

(51) Int. Cl. H04W 36/22

(52) U.S. Cl. CPC H04W 36/22
USPC 455/439

(57) ABSTRACT

A method for managing a network includes determining whether to transfer data between a terminal and a controller of a first cell or between the terminal and a controller of a second cell based on at least one traffic parameter of the terminal. The first cell has a first size and the second cell has a second size different from the first size, and the network is a heterogeneous network. The method also includes a multi-streaming operation in which different portions of requested content is transmitted to the terminal through controllers of the different cell areas based on the traffic parameter of the terminal.

### BACKGROUND OF THE INVENTION

One or more embodiments relate to network communications.

Communication networks continue to evolve to meet consumer demand for faster and more efficient dissemination of information including multimedia data. While several solutions have been proposed for increasing the throughput and efficiency of data transmissions on these networks, improvements are still required.

One type of network for which improvements are required is known as a heterogeneous network. A heterogeneous network (or HetNet) is an integrated system of wireless networks of different cell sizes with varying power and possibly access technologies. In such a network, handoff operations are performed to transfer traffic between larger and smaller cells. These operations may free network resources for the larger cells so that they can maintain a certain level of performance to customers.

One drawback of a HetNet relates to the inability of user equipment to properly operate as a result of interference among the networks. This may take place, for example, when transmissions from a macro cell interfere with communications in an overlapping smaller-sized cell. This interference may inhibit proper performance of handoff operations between the cells and also may limit the range and/or ability to perform communications for terminals in the smaller-sized cell.

### SUMMARY OF THE INVENTION

In accordance with one embodiment, a method for managing a network includes determining whether to transfer data between a terminal and a controller of a first cell or between the terminal and a controller of a second cell based on at least one traffic parameter of the terminal, the first cell has a first size and the second cell has a second size different from the first size, and the network is a heterogeneous network.

The determining operation may include determining to transfer of data between the terminal and the controller of a first cell when the traffic parameter is in a first range, and determining to transfer of data between the terminal and the controller of a second cell when the traffic parameter is in a second range different from the first range.

The controller operation may include controlling transfer of the data between the terminal and the controller of the first cell when the terminal is in a cell extended region of the second cell. The at least one traffic parameter includes at least one of traffic load, channel rate, or amount of additional data to be transferred to the terminal. The first cell may be a macro cell and the second cell may be a micro cell, femto cell, or pico cell.

Additionally, the method may include controlling performance of a multi-streaming operation which includes controlling transfer of a first fraction of data between the controller of the first cell and the terminal and controlling transfer of a second fraction of data between the controller of the second cell and terminal.

Additionally, the method may include controlling transfer of data between the terminal and the controller of the first cell in a first period of a duty cycle, and controlling transfer data between the terminal and the controller of the second cell in a second period of the duty cycle, one of the first or second periods corresponding to a blanking period of the first cell or the second cell.

In accordance with another embodiment, a network manager comprises a receiver to receive information indicative of at least one traffic parameter of a terminal, and a controller to a controller configured to determine whether to transfer data between a terminal and a controller of a first cell or between the terminal and a controller of a second cell based on at least one traffic parameter of the terminal. The first cell may have a first size and the second cell may have a second size different from the first size, and the first and second cell areas included in a heterogeneous network.

The controller of the network manager may control performance of a hand off operation between the controllers of the first and second cells after the terminal enters in a cell extended region of the second cell area. The controller may control performance of the hand off operation based on the change in the at least one traffic parameter of the terminal.

Also, the controller may control transfer data between the terminal and the controller of the first cell in a first period of a duty cycle, and transfer data between the terminal and the controller of the second cell in a second period of the duty cycle, one of the first or second periods corresponding to a blanking period of the first cell or the second cell.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 shows an example of a heterogeneous network.

FIGS. 2A and 2B show examples of control devices in a network.

FIG. 3 shows an embodiment of a method for managing communications in a network.

FIG. 4 shows an example of a CRE region of a pico cell.

FIGS. 5(A) to 5(C) show operational times of cell controllers.

FIG. 6 shows another embodiment of a method for managing communications in a network.

FIGS. 7(A) and 7(B) show comparative examples of the performance of non-adaptive and adaptive systems.

### DETAILED DESCRIPTION OF THE EMBODIMENTS

Various example embodiments will now be described with reference to the accompanying drawings in which some example embodiments are shown.

While example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or sometimes executed in reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of algorithms performed by a controller. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements, existing end-user devices and/or post-processing tools (e.g., mobile devices, laptop computers, desktop computers, etc.). Such existing hardware may include one or more Central Processing Units (CPUs), digital signal processors (DSPs), application-specific-integrated-circuits (ASICs), field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Note also that the software implemented aspects of example embodiments are typically encoded on some form of tangible (or recording) storage medium or implemented over some type of transmission medium. As disclosed herein, the term “storage medium” may represent one or more devices for storing data, including read only memory (ROM), random access memory (RAM), magnetic RAM, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code or code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “terminal” may be synonymous to a mobile user, mobile station, mobile terminal, user, subscriber, wireless terminal, user equipment and/or remote station and may describe a remote user of wireless resources in a wireless communication network. Accordingly, terminal may be a wireless phone, wireless equipped laptop, wireless equipped appliance, etc.

The term “base station” may be understood as a one or more cell sites, base stations, nodeBs, enhanced NodeBs, access points and/or any terminus of radio frequency or other wireless communication. Although current network architectures may distinguish between mobile/user devices and access points/cell sites, the example embodiments described hereafter may generally be applicable to architectures where that distinction is not so clear such as ad hoc and/or mesh network architectures.

Communication from the base station to the terminal is typically called downlink or forward link communication. Communication from the terminal to the base station may be called uplink or reverse link communication.

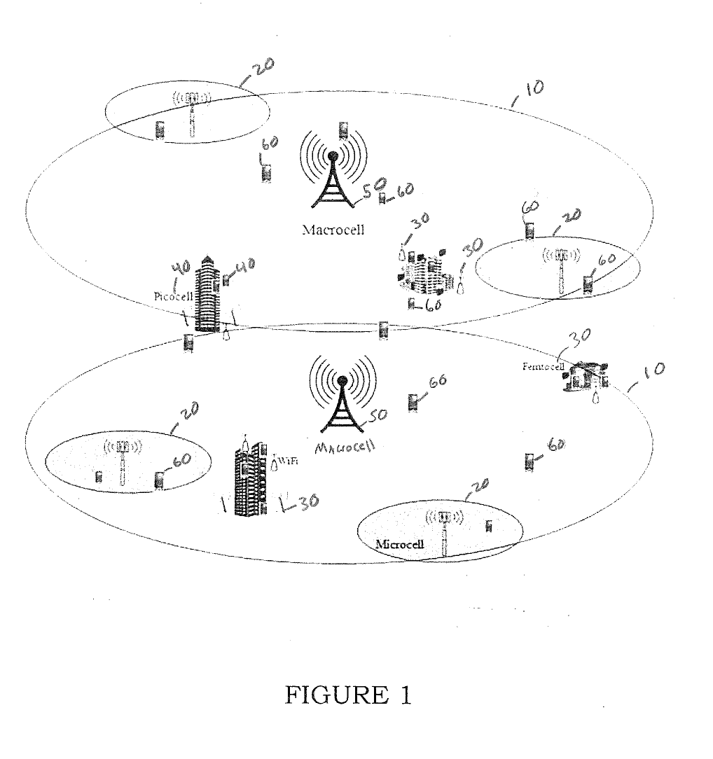

FIG. 1 shows an example of a heterogeneous network which includes a plurality of macro cells 10, each including a macro cell controller 50 for performing various operations for communicating data between and among network devices and one or more user equipment (UE). The UEs may be mobile terminals such as smart phones, computer terminals, tablets, pad-type device, and other types of user terminals for receiving and transmitting data through the network.

As shown in FIG. 1, each macro cell may overlap a plurality of smaller-sized cells. In this example, the smaller-sized cells include a number of micro cells 20, femto cells 30, and pico cells 40, each of which may include a respective controller for managing communications with user terminals 60. The smaller-sized cells may be included entirely within a larger one of the cells or may partially overlap the larger cells. The cells may communicate using different standards and/or frequency spectrums to transmit and receive content in their coverage areas. For example, a smaller cell may communicate based on a WiFi standard and larger size cells may use one or more multiple access protocols including but not limited to a CDMA, GSM, or LTE standard.

When a user terminal is simultaneously located in coverage areas of different size cells, interference (e.g., co-channel interference) may reduce the quality of communications of the user terminal. In accordance with one embodiment, at least one traffic parameter of a user terminal is taken into consideration in determining which cell area controller will communicate with the user terminal. Based on the at least one traffic parameter, communications may be established and/or hand off operations may be performed in a manner that improves the balance of load across the entire network. This may result in more reliable communication to the user terminal while simultaneously employing efficient spectral allocation among the controllers of the network cells.

In accordance with a further embodiment, this technique of establishing communications or performing hand off operations may be synchronized with macro cell blanking to provide an additional degree of interference mitigation in the network, especially for terminals located beyond a nominal coverage area of a smaller-sized cell, e.g., for terminals located in a cell range extended (CRE) region of a smaller-sized cell.

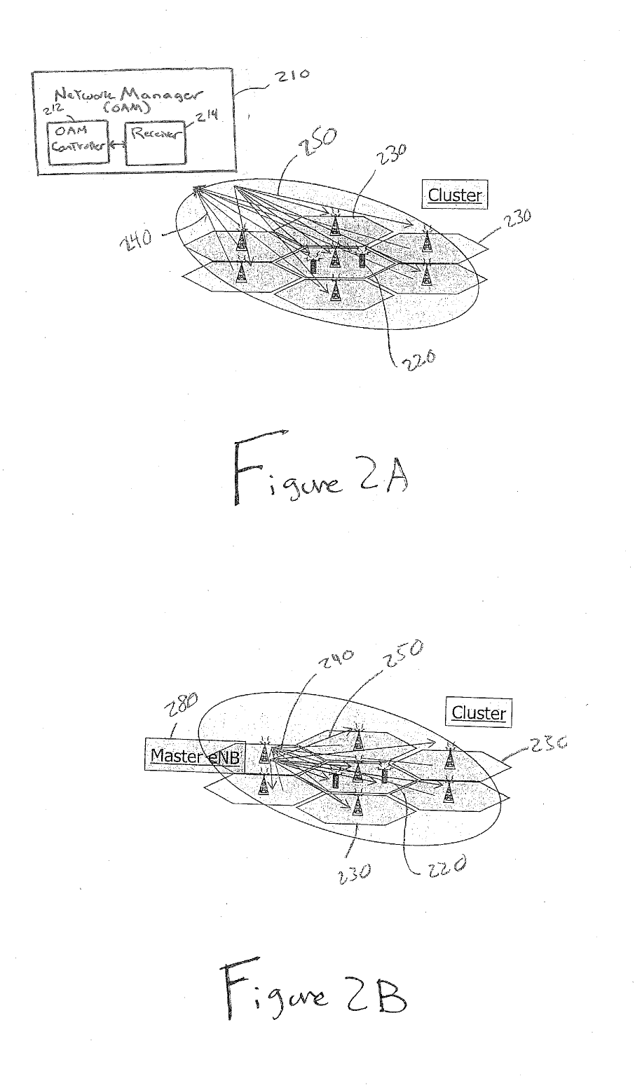

FIGS. 2A and 2B show examples of different types of control devices in the network that may implement one or more embodiments of the methods described herein. In FIG. 2A, an operation and management (OAM) device 210 of the network governs the establishment of communications and/or performance of hand off operations for user terminals 220 in a cluster of cells 230 of the network. The cells may include one or more of the smaller-sized cells in one macro cell, or the cells may include smaller-sized cells in different macro cells of the heterogeneous network.

In this embodiment, the OAM is configured to manage communications with the user terminals in the cluster of cells. This may be accomplished by receiving information indicative of at least one traffic parameter associated with one or more of the user terminals in a cluster along links 240. This information may be received from one or more controllers of respective cells. In addition to the at least one traffic parameter, additional information including link information may be transmitted from the controllers of the cluster cells to the OAM.

The OAM may then transmit control signals 250 to the controllers of the cells to control the establishment of connections and/or hand off operations for the terminals in the cells based on the at least one traffic parameter. The link information may also be taken into consideration to control the connections and hand off operations.

In FIG. 2B, a radio access network (RAN) device 280 receives the at least one traffic parameter from the cell controllers and generates the control signals for controlling the establishment of communications and/or hand off operations of the terminals for the cells. The RAN device may be, for example, radio network controller (RNC), a type of Node B, a gateway controller, mobile switching center, base station, or another device dedicated to performing one or more operations in the network.

The OAM device, RAN device, or other devices mentioned above may be considered to be network managers. Because these devices may send control signals to both the larger cell controller and the smaller cell controller, operations of one or more embodiments of the methods described herein may be performed in the network manager. In some embodiments, the individual cell controllers may be considered network managers.

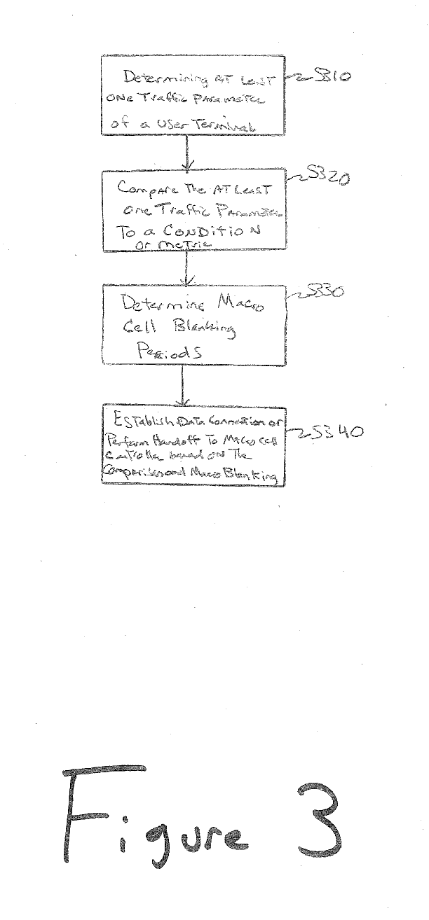

FIG. 3 shows operations included in one embodiment of a method for managing communications in a network. As previously indicated, the network may be a heterogeneous network. In other embodiments, the network may be a different type of network, e.g., ones including cell areas of substantially the same type.

An initial operation includes determining at least one traffic parameter of a terminal. (S310). The traffic parameter may be determined by the user terminal and/or a controller of a cell area in the network with which the terminal is currently communicating or which is currently monitoring the terminal. In accordance with control software, the terminal and/or cell controller may transmit periodic reports including information indicative of the at least one parameter of the terminal to a network manager. The network manager may be the controller of a larger-sized cell, an OAM or a RAN device as previously discussed. In addition to or in lieu of periodic reports, traffic parameter information may be included in one or more existing control messages transmitted in the network.

The traffic parameter may be one of a traffic load of the user terminal, a load the terminal is expected to receive based on content requested by the terminal or which the terminal is otherwise to receive, a data rate associated with a channel or link to the terminal, a total amount of data associated with the requested content or a remaining portion of the requested data to be downloaded to or otherwise transferred to terminal. In accordance with one embodiment, a combination of these or other parameters relating to the user terminal may be determined in initial operation 310.

The content requested or otherwise to be received by the user terminal may be media content, web browsing content, voice (e.g., voice-over-IP) content, email, instant or other types of messages, navigation information, games or gaming-related information, control information, software updates or new software, applications, or other types of information that be requested or otherwise transmitted to a user terminal in a network.

In accordance with one embodiment, user terminal or cell controller may transmit information indicative of a location of the user terminal relative to one or more cells. This information may indicate, for example, whether a user terminal is currently in a cell range extended (CRE) area of a smaller cell area that overlaps a larger cell area.

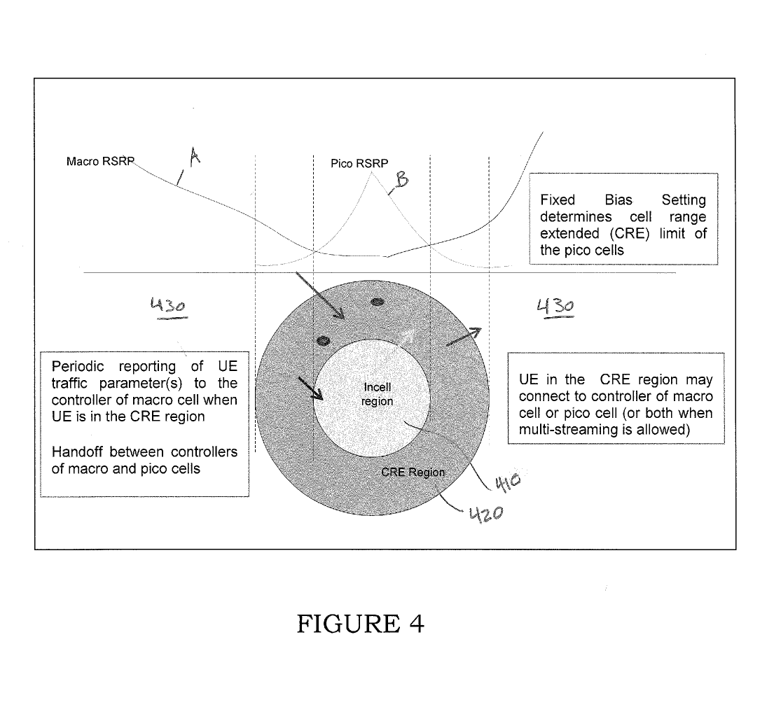

FIG. 4 shows an example of a user terminal in a CRE region of a smaller-sized cell, which in this case is illustratively shown to be a pico cell. As shown in FIG. 4, the pico cell includes an in-cell region 410 which and CRE region 420 which represents an extension of the in-cell region. The region 430 represents the area of macro cellular coverage alone.

The in-cell region is a region in which only the controller of the pico cell controls communications of data with the user terminal. This region may correspond to some set range determined in advance by the network or otherwise may be set by a control parameter of the pico cell controller or a network authority. This control parameter may include the fixed bias setting indicated in FIG. 4, for determining the CRE region limit of the pico cell.

When in the in-cell region, the user terminal may be in an overlapping region of a larger cell. However, the user terminal may be programmed to disregard data or other messages from the larger cell controller and only sustain data communications with the pico cell controller. In an alternative embodiment, the user terminal may still maintain communications with the macro cell controller in tennis of control signals, synchronization signals, or other signals in order to, for example, allow for hand off or otherwise for purposes of receiving data from the macro cell controller in accordance with one or more embodiments described herein.

When in the CRE region, the pico cell controller (which monitors the location of the user terminal) may send a message to a network manager to report that the user terminal is in the CRE region. Alternatively, the macro cell controller or another cell controller which was connected to the user terminal prior to entering the CRE region may monitor the location of the user terminal and then perform this reporting function t the network manager.

Additionally, or alternatively, the user terminal may monitor its location relative to the pico cell controller or the macro cell controller and report a message to this controller indicating that the CRE region has been entered. The pico cell controller or macro cell controller may then convey this information to the network manager.

In FIG. 4, a graph is shown relative to the in-cell and CRE regions. In this graph, Curve A corresponds to a reference signal received power (RSRP) for the macro cell. This RSRP curve provides a measure of signal power throughout various regions in the macro cell that includes the pico cell region. As shown by Curve A, power of the macro cell decreases in a direction approaching the pico cell CRE region and evens out to substantially a minimum or low value in the in-cell region. The power then increases as the distance from the pico cell increases.

Curve B corresponds to a reference signal received power (RSRP) for the pico cell. In contrast to Curve A, the power represented by Curve B increases as a user terminal approaches the CRE region and peaks in the in-cell region. As will be explained in greater detail below, when a user terminal is in the pico cell region, a control operation may be performed to establish a connection with the macro cell controller for communicating data or to perform a hand off operation to the macro cell controller for data communications based on the at least one traffic parameter determined in Block 310.

This control operation may be performed when the user terminal is in the in-cell region or the CRE region, or at both times, depending on the traffic parameter. (In a multi-streaming embodiment discussed in greater detail below, the user terminal may simultaneously be connected to the pico cell and macro cell controllers and receive portions of same content from these cell controllers at different times).

Referring again to FIG. 3, once the at least one traffic parameter has been determined, this/these parameters are compared by the network manater to at least one condition or metric. (S320). The condition is based on the type of traffic parameter determined. For example, the at least one condition or metric may be based on a certain level of traffic load, a certain channel data rate, an expected data rate or capacity of data to be transferred to the user terminal, and/or a certain amount of remaining data to transferred to a user terminal. In one embodiment, the at least one condition may be based on the aggregate traffic headroom left at a cell and/or the amount of headroom at the target cells (if a serving cell congested, and a target cell can accept). In other embodiments, a plurality of traffic parameters are compared to a plurality of respective conditions or metrics.

The comparison determined in operation S320 may be made in conjunction with a determination as to blanking periods of the macro cell. (S330). For example, the blanking periods may be known in advance in the network (e.g., the network manager and/or cell controllers). Alternatively, the determination of the blanking periods of the macro cell may be determined jointly with the determination of which cell is to form a data connection with the user terminal.

Further, and in accordance with one embodiment, the expected service quality of a user terminal at each cell may depend on the amount of blanking. In this case, each value of blanking may be evaluated in view of the data connections that may be available between the user terminal and available cell controllers, and the blanking value and cell controller selected which demonstrates an optimal or desired level of performance may be chosen. These determinations and operations may be performed by the network manager and/or the cell controllers.

Additionally, macro cell blanking may be performed by the macro cell controller to reduce interference at a user terminal as a result of transmissions from the macro cell controller to other user terminals, when the user terminal is receiving transmissions from a smaller cell controller. In accordance with one technique, macro cell blanking involves transmitting blank or almost blank sub-frames (ABS) in its cell region.

The blank or almost blank sub-frames include no data, but may include some information. For example, ABS sub-frames may correspond to lower power signals transmitted as synchronization signals, reference signals, or paging signals. Because these signals are of low power, they cause less, if any, interference to the user terminal in the in-cell or CRE regions of the pico cell. In accordance with one embodiment, the connection or hand off operation of the user terminal to the macro cell controller may be performed based on or in conjunction with macro cell blanking.

Based on the comparison in operation S320 and the determination of macro cell blanking periods in operation in S330, a decision is made by the network manager as to whether to establish a data connection between the macro cell controller. (S340). The data connection may be established based on entry of the user terminal into one of a CRE region or in-cell region of the pica cell. Additionally, or alternatively, the connection may be established based on a hand off operation performed from the pico cell controller to the macro cell controller.

In either case, and in accordance with at least one embodiment, detecting that the user terminal has entered into the CRE region of the pico cell may not serve as the sole basis for establishing the data connection to the user terminal or for performing the hand off operation. Rather, the data connection may be established or the hand off operation performed based on the at least one traffic parameter of the user terminal.

Using this criteria for data connection and/or hand off may allow a user terminal to receive data from the macro cell controller irrespective of the size of the received signal strength of the user terminal in the pico cell relative to the size of the received signal strength of the user terminal in the macro cell. For example, data connection or hand off to the macro cell controller may be performed even when the received signal strength of the user terminal in the pico cell is greater than the received signal strength in the macro cell, and/or even when traffic or network conditions at the macro cell controller are more favorable (e.g., more available headroom or capacity) than traffic or network conditions at the pico cell controller.

In accordance with one embodiment, a metric that may be taken into consideration in operation S320 is the time to completion (delivery) of packets in the network. For example, let T_{c} be the expected time to completion of all packets at a particular cell under the assumption that a particular set of users is connected to, and served by, that cell. The utility, or measure of value, that may be used for controlling data connections or hand off operations, in conjunction with the amount of blanking at the macro cells, may be ΣT_{ci} which corresponds to the sum of the expected times to completion at each of the cells, indexed by ‘i’, in the network. This utility may be minimized or reduced subject to the constraint that none of the user terminals experience an excessive delay. (An excessive delay may be considered to be a delay greater than a reference delay).

Alternatively, in accordance with one embodiment, a constraint may be imposed on the delays at each cell, as opposed to individual user terminals. The formulation may therefore be revised to constrain each cell to deliver its packets within a certain time. This latter constrained formulation may illustratively be represented as:

minᵢΣT_{ci},subject to T_{ci}<T for all i

In such a formulation, the determination of T is empirical and may be determined, for example, based on an aggregate network load and expectation of spectral efficiency from the system. The user terminal association (e.g., connection of a user to a macro cell controller) based on terminal traffic load conditions and macro cell blanking that minimize load and increase spectral efficiency in view of the aforementioned constraints may serve as a basis for establishing a data connection between the user terminal and macro cell controller when the user terminal is in the pico cell CRE region. These factors may be expressed as a linear program which is easily solvable in real time.

An alternative approach may involve minimizing a metric that corresponds to the largest cell completion time. This can be expressed as min maxᵢ T_{ci}, which can be rewritten as min T subject to the constraints T_{ci}<T∀i. In accordance with one embodiment, the variable T being minimized may be the largest of the individual cell completion times. This representation may alleviate the performance of an empirical determination of T which is the variable to be minimized. The set of cells, {i}, for which the maximum cell completion time to be minimized may correspond to a single cell or a group of cells in a certain area or sector of the network.

Both the min-sum of the cell time to completion and min-max-cell time to completion described above may be solved in the following manner, and either can be used to optimize network performance depending on operator preference.

In accordance with one embodiment, the cell completion time allows at least one traffic parameter (or traffic profile) of a user terminal to be taken into consideration for purposes of establishing a data connection to that terminal and/or to perform a hand off operation from the controller of one cell to another, e.g., from a smaller-sized (e.g., pico) cell to a larger-sized (e.g., macro) cell when the terminal is in the annulus specifying the pico CRE region, either assuming a pre-existing value, determining a new value, or changing a prior value, of the macro blanking to be used. Under a one user-at-a-time transmission scheme, the cell completion time may be written as:

$${T}_{ci} = {\sum }_{j ∈ SP ( i )} \frac{{B}_{ij}}{{R}_{ij}}$$

In this equation, the term Bᵢⱼ corresponds to the quantum of data to be transmitted to user j from cell i, and Rᵢⱼ is the channel rate at cell i for user j assuming that this user is in the pool of schedulable users at cell i. Also, SP(i) refers to the scheduling pool of active users connected to cell i. Because the macro cell is blanked to enable communication between the pica cell and user terminal in the cell range extended region of the pico cell, the time to completion at the macro cell may alternatively be expressed as:

$${T}_{c M} = {\sum }_{j ∈ SP ( M )} \frac{{B}_{Mj}}{( 1 - θ ) {R}_{Mj}}$$

where θ corresponds to the fraction of time for which the macro cell is blanked, e.g., is the time a blanking or ABS sub-frame is to be transmitted from the macro cell controller.

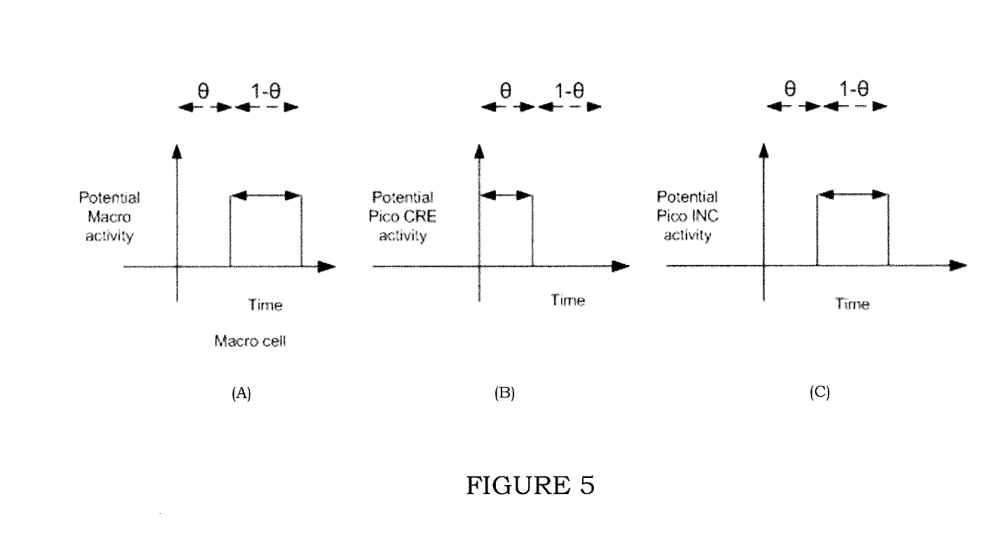

FIGS. 5(A) to 5(C) shows examples of operational times of the macro and pico cell controllers. FIG. 5(A) shows what is in effect a duty cycle corresponding to operation of the macro cell controller. This duty cycle includes a first time θ in which a blank or ABS sub-frame is transmitted and a second time 1-θ in which data signals are transmitted from the macro cell controller.

FIG. 5(B) shows a duty cycle corresponding to operation of the pico cell controller. This duty cycle includes the same θ and 1-θ. However, the first time θ serves as a time in which a connection between the macro cell controller and the user terminal in the CRE region of the pico cell may be established, or when a hand off operation from the pico cell controller to the macro cell controller may be performed based on at least one traffic parameter of the user terminal.

FIG. 5(C) shows the time period 1-θ in which the user terminal may operate in the in-cell region of the pico cell. In this time period, the user terminal may be connected to the pico cell controller.

### Multi-Streaming

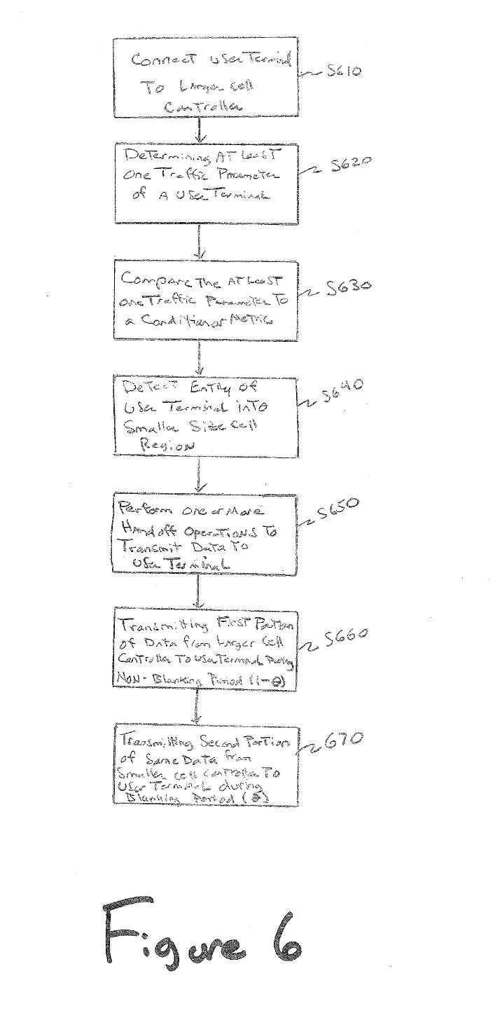

FIG. 6 shows one embodiment of a method for multi-streaming content to a user terminal in an area which is covered by larger and smaller cells. The operations of this method may be performed by a network manager as previously described based on information received by one or more cell controllers and/or the user terminal itself.

An initial operation includes connecting a user terminal to the controller of a large cell. (S610). This connection may be established based on exchange of control signals between the user terminal and the large cell controller. The connection may not necessarily be a data connection at this point, but rather may merely involve, for example, registering the terminal in a home location register (HLR) of the network. Moreover, the connection may be established by or based on functions performed by a network manager.

Once the connection has been established, at least one traffic parameter of the user terminal may be determined. (S620). This operation may be performed by the network manager such as an OAM, RNC, or cell controller or may be performed by the user terminal in a manner as previously described in relation to other embodiments. If performed by the user terminal, information indicative of the traffic load may be transmitted to the network manager for consideration in performing subsequent operations of the method.

After operation S620, the at least one traffic parameter is compared to a metric or condition. (S630). This comparison step may be performed by the network manager or user terminal and may involve a comparison similar to operation 320 previously discussed. If performed by the user terminal, a result of the comparison may be transmitted to the network manager.

In alternative embodiments, a different condition or metric may be used such as described in greater detail below. In this alternative case, the condition or metric may not be compared directly to the at least one traffic parameter but rather may be used as a basis for determining when the controllers of different size cells are to transmit data to the user terminal within the two different periods of a duty cycle of the larger size cell. Instead of a duty cycle per se, the controllers of the different size cells may transmit data to the user terminal within a cycle comprising consecutive blanked and non-blanked intervals.

A next operation includes detecting entry of the user terminal into a region of a smaller size cell. (S640). This operation may be performed by the user terminal and/or a cell controller and/or other type of network manager. For example, a cell controller may monitor the location of the user terminal to detect entry of the terminal into a region of the smaller cell.

A next operation includes performing one or more handoff operations between the controllers of the smaller and larger size cells, for the purpose of transmitting data to the user terminal. (S650). The handoff operations may be controlled by a network manager based on detection of the user cell into the smaller cell and based on the at least one traffic parameter of the user terminal and the metric or condition previously discussed. An example of how all of these factors are taken into consideration in performing the hand off operation is discussed in greater detail below.

The hand off operation(s) is/are performed in order to transfer data to the user terminal through different cell controllers. Depending on the amount of data to be transferred, the hand off operations may be repeatedly performed until all the data has been transferred. The data may be requested by the user terminal or may be data to be transmitted to the user, for example, from the cell controller(s) or other network manager without request.

In accordance with FIG. 4, three regions 410, 420, and 430 are defined. In regions 410 and 430 the UE may only associate with the pico and macro respectively. In region 420, the UE may associate with the either macro, pico, or both when multi-streaming is allowed. The inner and outer contours defining the region 420 may be selected based on deployment considerations. Using moving outwards across the outer contour and users moving inwards across the inner contour are handed off, if they are not already associated, to the macro cell and pico cell respectively. Users moving inwards across the outer contour and outwards across the inner contour are put into association with both macro and pico cell, when multi-streaming is allowed.

In accordance with one embodiment, a first portion of data is to be transmitted to the user terminal from the controller of the larger size cell in a first time period (S660) and a second portion of the same or different data may be transmitted to the user terminal from the controller of the smaller size cell in a second time period (S670). The first and second time periods may be different periods of a macro blanking duty cycle or may be different periods of time in another type of duty cycle or period. An example of a macro blanking duty cycle is described in greater detail below.

A multi-streaming embodiment for transmitting data to a user terminal from macro cell and pico cell controllers will now be described. In this embodiment, operation of the pico cell controller may be synchronized with the blanking period of the macro cell, for purposes of allowing data to be multi-streamed to the user terminal. In accordance with one embodiment, the expected time to completion for a pico cell may be expressed as:

$${T}_{cp} = {\sum }_{j ∈ SP ( {p}_{in} )} \frac{{B}_{pj}}{( 1 - θ ) {R}_{pj}} + {\sum }_{j ∈ SP ( {p}_{cre} )} \frac{{B}_{pj}}{( θ ) {R}_{pj}} = {T}_{{cp}_{in}} + {T}_{{cp}_{cre}}$$

Based on this completion time, a user terminal in the CRE region of the pico cell may be scheduled to receive data from the pico cell controller when the macro cell controller is in an ABS or blanking period. During this period, the pico cell controller may transmit data to the user terminal at a channel rate calculated on the assumption that the macro cell is blanked. A user terminal in the in-cell region of the pico cell area may have a channel rate that factors in interference from the macro cell.

During multi-streaming, the user terminal may receive data from both the pico cell and macro cell controllers based on one or more traffic terminal parameters. More specifically, the macro cell controller may be connected to transmit data to the user terminal when the terminal is in the CRE region of a pico cell area and the macro cell controller is operating in the transmitting time period 1-θ. The pico cell controller may be connected to transmit data to the user terminal when the user terminal is in the CRE region of the pico cell area and the macro cell controller is operating during the blanking (or ABS) time period θ.

This approach, which may be referred to as a relaxation technique, may therefore allow data bits of content to be delivered to the user terminal in some proportion from the controllers of multiple candidate cells of different cell sizes. The content may be requested by the user terminal or otherwise may be scheduled for transmission to the user terminal without request. As a result of applying this multi-streaming relaxation approach, user terminals in the cell range extended area of the pico cell are allowed to receive their data bits Bⱼ as

Bⱼ=B_{Mj}+Bₚⱼ

where B_{Mj} and Bₚⱼ are the bits delivered to the user terminal from the macro cell and pico cell controllers, respectively. This approach may be employed irrespective of one or more traffic parameters of the user terminal or by taking one or more traffic parameters into consideration. For example, in this latter case, the relaxation approach may be applied only when one or more traffic parameters of the terminal fall into a certain range.

In an alternative embodiment, relaxation multi-streaming may be applied even when the user terminal is in the in-cell region of the pica cell area. For example, this approach may be taken when the traffic load of the macro cell controller falls below a certain reference level and the traffic load of the pico cell controller exceeds a certain reference level. In this case, the macro cell controller may be in a better position (at least from a spectral capacity perspective) to transmit data to the user terminal than the pico cell controller, and this approach may be applied when the user terminal is in either or both of the CRE region and in-cell region.

In another multi-streaming embodiment, a multi-streaming set for a user terminal j may be denoted by MS and a non zero Bᵢⱼ may be allowed only for cells iεMS(j), the Bᵢⱼ still summing to Bⱼ. For a particular value of θ, a knowledge of the channel rates, and the total pending data (remaining data of content, i.e. Bⱼ) to be transmitted to the user terminal, the only unknowns are the bits to be delivered from each candidate cell (the multi-streaming set). This is a linear program that can be easily solved using a number of available commercial solvers.

Also, according to this embodiment, the macro blanking duty cycle may be determined at the same time the decision is made as to which cell controller is to transmit data to the user terminal. A range of values for the macro blanking time θ (e.g., from 0 to 0.6 in increments of 0.1) may be set and a specific blanking time in this set may be selected based on the θ increment and the user terminal-to-cell association (which may be determined based on the number of bits to be delivered from each network controller) that provides the smallest time to completion. (The user terminal-to-cell association may be understood to mean which controller (e.g., macro cell controller or pico cell controller) is to be used in transmitting data to the user terminal when the user terminal is in the pico cell area).

By performing this approach in the time domain, the user terminal-to-cell association problem may be expressed and solved as a linear program that also takes the user terminal traffic characteristics into account. Cell association for the multi-streamed user terminals may be determined, for example, based on control software that tosses a biased coin in favor of the cell from which a greater fraction of the data is required to be transmitted.

In the multi-streaming embodiments described above, the fractions of the data content to be transmitted from the two base stations may be determined based on traffic parameters of all or a subset of user terminals in the affected cell regions and/or in the network. Additionally, the fractions of the data content to be delivered to the user terminal from respective cell controllers may be used to parse and route the incoming data flow for the appropriate cell.

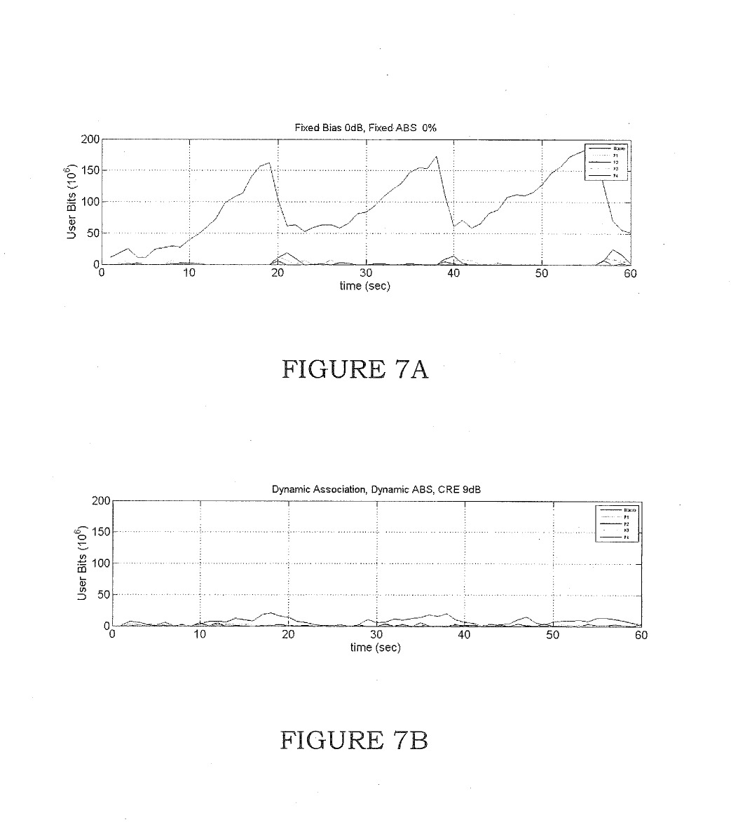

FIGS. 7A and 7B compare the transmission of data in a system which does not employ the embodiments described herein to an example of the aforementioned embodiment which takes one or more traffic parameters of a user terminal into consideration when delivering data to a user terminal.

FIG. 7A shows the transmission of data in a non-adaptive system in which a user terminal received data based on a fixed ABS 0% and a fixed bias of 0 dB.

FIG. 7B shows an example of gain that may be obtained from an embodiment applied to a heterogeneous network system simulation with user mobility and traffic dynamics, where macro blanking based on the min-time metric previously discussed is used. The equalization in pending data (or remaining data to be transferred to the user terminal) at the macro cell is shown as well as for embedded pico cells.

The improved performance for this example embodiment is evident from the following table, which shows that more files were delivered and fewer files where dropped compared to the non-adaptive system of FIG. 6A.

| | #Files | | | | |
|---|---|---|---|---|---|
| | Trans- | #Files | E[Delay] | E[FTT] | E[Queue |
| Metrics | mitted | Dropped | (TTI) | (TTI) | Length] |
| Non-Adaptive | 2079 | 176 | 1689 | 2380 | 109.23 |
| System: Fixed | | | | | |
| ABS (0 dB, 0% | | | | | |
| ABS) | | | | | |
| Adaptive | 2310 | 0 | 145 | 416 | 16.27 |
| System: (CRE | | | | | |
| 9 dB) | | | | | |

Referring to FIGS. 2A and 2B, by virtue of having access to periodic measurement reports of all the user terminals in a cell range extended region of a smaller-sized (e.g., pico, femto, micro) cell, the expected data rate at the macro cell (for those user terminals currently connected to received data from the smaller-sized cell controller) and the expected data rate at the pico cell (for those user terminals currently connected to receive data from the macro cell controller) can be computed.

Thus, the TTCs at both the macro and pico are known except for the variables, θ, and the bit splits {B_{Mj}, Bₚⱼ} for the users in the CRE region. The solution method described above may be implemented at the central entity (e.g., OAM, master eNodeB, or a cell controller) and the macro blanking duty cycle effected across the macro cell cluster. Furthermore, the macro and pico cell eNBs may be directed to initiate handover of user terminals in the CRE region that are currently served by them, to designated target eNBs as required by user terminal-to-cell associations determined accordance with the embodiments described herein.

Another embodiment corresponds to a computer-readable medium that stores code or other instructions for performing operations in any of the aforementioned embodiments. The code may be stored, for example, in a network device which controls or otherwise communicates with both the smaller-sized and larger-sized cell controllers or the code may be stored in one or more of the cell controllers. The medium may be any type of memory or storage device for controlling a processor to perform all or a portion of the respective operations of the methods described herein.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

We claim:

1. A method for managing a network, comprising:
determining whether to transfer data between a terminal and a controller of a first cell or between the terminal and a controller of a second cell based on at least one traffic parameter of the terminal, the first cell has a first size and the second cell has a second size different from the first size, and the network is a heterogeneous network.

2. The method of claim 1, wherein the determining includes
determining to transfer of data between the terminal and the controller of a first cell when the traffic parameter is in a first range, and
determining to transfer of data between the terminal and the controller of a second cell when the traffic parameter is in a second range different from the first range.

3. The method of claim 1, wherein
the first cell size is greater than the second cell size, and
the first cell includes or overlaps the second cell.

4. The method of claim 1, wherein the determining determines whether to transfer data between a terminal and a controller of a first cell or between the terminal and a controller of a second cell based on at least one traffic parameter of the terminal and whether the terminal is in a cell extended region of the second cell.

5. The method of claim 1, further comprising:
controlling performance of a hand off operation between the first cell and second cell based on a change in the at least one traffic parameter of the terminal.

6. The method of claim 5, wherein the controlling includes:
controlling performance of the hand off operation when the terminal is closer to the controller of second cell than the controller of the first cell, and
the first cell size is larger than the second cell size.

7. The method of claim 5, wherein the determining determines whether to transfer data between a terminal and a controller of a first cell or between the terminal and a controller of a second cell based on at least one traffic parameter of the terminal and available traffic capacities of the first cell and the second cell.

8. The method of claim 1, wherein the at least one traffic parameter includes at least one of traffic load, channel rate, or amount of additional data to be transferred to the terminal.

9. The method of claim 1, wherein
the first cell corresponds to a macro cell, and
the second cell corresponds to a micro cell, femto cell, or pico cell.

10. The method of claim 1, further comprising:
controlling performance of a multi-streaming operation which includes,
controlling transfer of a first fraction of data between the controller of the first cell and the terminal, and
controlling transfer of a second fraction of data between the controller of the second cell and the terminal.

11. The method of claim 10, wherein
the first fraction of data corresponds to a first number of bits and the second fraction of data corresponds to a second number of bits, and
the first number of bits and the second number of bits included in a total number of bits of content requested by the terminal.

12. The method of claim 1, further comprising:
determining to transfer the data between the terminal and the controller of the first cell in a first period of a duty cycle, if the determining determines to transfer data between the terminal and the controller of the first cell, and
determining to transfer the data between the terminal and the controller of the second cell in a second period of the duty cycle, if the determining determines to transfer data between the terminal and the controller of the second cell, one of the first or second periods corresponding to a blanking period of the first cell or the second cell.

13. A network manager comprising:
a receiver configured to receive information indicative of at least one traffic parameter of a terminal; and
a controller configured to determine whether to transfer data between a terminal and a controller of a first cell or between the terminal and a controller of a second cell based on at least one traffic parameter of the terminal, the first cell has a first size and the second cell has a second size different from the first size, and the network is a heterogeneous network.

14. The network manager of claim 13, wherein
the first cell size is greater than the second cell size, and
the first cell includes or overlaps the second cell.

15. The network manager of claim 13, wherein the controller is configured to control performance of a hand off operation between the controllers of the first and second cells after the terminal enters in a cell extended region of the second cell area.

16. The network manager of claim 13, wherein the controller is configured to control performance of the hand off operation based on a change in the at least one traffic parameter of the terminal.

17. The network manager of claim 13, wherein
the first cell size is larger than the second size,
the terminal is in a cell extended region of the second cell, and
the controller determines to transfer the data between the terminal and the controller of the first cell when the terminal is closer to the controller of second cell than the controller of the first cell.

18. The network manager of claim 13, wherein the controller is configured to
determine to transfer the data between the terminal and the controller of the first cell in a first period of a duty cycle, if the controller determines to transfer the data between the terminal and the controller of the first cell, and
determine to transfer the data between the terminal and the controller of the second cell in a second period of the duty cycle, if the controller determines to transfer the data between the terminal and the controller of the second cell, one of the first or second periods corresponding to a blanking period of the first cell or the second cell.

19. The network device of claim 13, wherein the at least one traffic parameter includes at least one of traffic load, channel rate, or amount of additional data to be transferred to the terminal.

20. The network device of claim 13, wherein
the first cell is to a macro cell, and
the second cell is a micro cell, femto cell, or pica cell.
